(19) United States
(12) Patent Application Publication
(10) Pub. No.: US 2013/0180929 A1
(43) Pub. Date: Jul. 18, 2013

(54) STORMWATER FILTRATION SYSTEMS AND RELATED METHODS

(71) Applicants: Gregory T. Kowalsky, Portland, OR (US); Adam A. Stevens, Hollis Center, ME (US)

(72) Inventors: Gregory T. Kowalsky, Portland, OR (US); Adam A. Stevens, Hollis Center, ME (US)

(21) Appl. No.: 13/740,905

(22) Filed: Jan. 14, 2013

Related U.S. Application Data
(60) Provisional application No. 61/599,654, filed on Feb. 16, 2012.
(60) Provisional application No. 61/586,497, filed on Jan. 13, 2012.

(51) Int. Cl. B01D 35/157

(52) U.S. Cl. CPC B01D 35/1573
USPC 210/744; 210/117; 210/119

(57) ABSTRACT

A stormwater filtration system includes one of a filter cartridge structure or a filter basket structure. The structure includes an internal collection space surrounded by a filter media bed, an outlet opening toward the bottom of the internal collection space for delivering water out of the structure, and a valve assembly associated with the outlet opening. The valve assembly is configured to provide a variable flow out of the outlet opening according to level of water within the internal collection space.

### CROSS-REFERENCES

This application claims the benefit of U.S. Provisional Application Ser. No. 61/586,497, filed Jan. 13, 2012 and 61/599,654, filed Feb. 16, 2012, the contents of each of which are incorporated herein by reference.

### TECHNICAL FIELD

This application relates generally to stormwater filtration systems and, more particularly, to systems incorporating live plant material into the filtration process.

### BACKGROUND

Stormwater can be a form of diffuse or non-point source pollution. It can entrain pollutants, such as trash, sediment, organic matter, heavy metals, and organic toxins, and flush them into receiving water bodies. As a consequence, natural bodies of water that receive stormwater may also receive pollutants. As used herein, the term stormwater refers to water produced as a result of a rain event, regardless of the source of collection (e.g., such as runoff from parking lots or other paved surfaces or water collected from rooftop gutter (or other collection and drainage) systems).

In an effort to address the environmental problems posed by polluted stormwater, traps and filters for stormwater have been developed.

Stormwater filtration cartridges, such as those described in U.S. Pat. Nos. 5,707,527, 6,027,639, 6,649,048, and 7,214,311, pull stormwater through a filtration bed that removes pollutants prior to discharge into a receiving water body. Improvements to such cartridges have produced highly effective filters that allow for significant throughput, as described in the references cited above, while also allowing for easy installation and replacement of the modular cartridge units.

Another known method of stormwater filtration involves the installation of horizontally-disposed filtration beds using a mixture of materials often including organic compost. Stormwater runoff directed into these beds is filtered in an action not unlike natural soil. Live plant material is sometimes added to take advantage of its pollutant uptake as well as for aesthetic value. However, such beds are generally permanent, and are not readily configured for replacement or cleaning of the bed. Moreover, installation of such beds requires significant on-site effort to achieve proper configuration of the bed, which often utilizes multiple layers. Scouring also tends to be an issue in such systems.

It would be desirable to develop a live plant matter filtration system that is simpler to install and is more readily adapted for cleaning or replacement. It would also be desirable to develop a live plant matter filtration system in which a more controlled flow through the filtration media is achieved.

### SUMMARY

In one aspect, a stormwater filtration system includes one of a filter cartridge structure or a filter basket structure, the structure including an internal collection space surrounded by a filter media bed, an outlet opening toward the bottom of the internal collection space for delivering water out of the structure, and a valve assembly associated with the outlet opening, the valve assembly configured to provide a variable flow out of the outlet opening according to level of water within the internal collection space.

In an embodiment, the valve assembly includes an outer tube, an inner tube positioned within the outer tube, the inner tube having a sidewall with at least one opening, the inner tube connected for movement by a float located in the collection space, the inner tube having a lowered position within the outer tube in which the sidewall opening is within the outer tube to prevent flow from the collection space through the sidewall opening, as the inner tube rises upward from the lowered position the sidewall opening is revealed to permit increasing flow through the sidewall opening and thus increasing flow through the structure.

In an implementation of the system according to either of the two preceding paragraphs, the valve assembly is configured to progressively increase a flow area of a valve passage as water level within the internal collection space rises. In another implementation of either of the two preceding paragraphs, the valve assembly is configured to linearly increase flow area of a valve passage as water level within the internal collection space rises.

In an embodiment, the valve assembly includes a tubular member disposed within a corresponding tubular surface, the tubular member having a sidewall with at least one opening, the tubular, member connected for movement by a float located in the collection space, the tubular member having a lowered position in which the sidewall opening is entirely or substantially entirely within the tubular surface to prevent or substantially restrict flow from the collection space through the sidewall opening, as the tubular member rises upward from the lowered position the sidewall opening is increasingly revealed to permit increasing flow through the sidewall opening and thus increasing flow through the structure.

In an implementation of the embodiment of the preceding paragraph, the tubular member is connected to the float via structure with an internal fluid passage that includes a lower end open to the internal passage of the tubular member and an upper opening located above the float to permit air to be drawn down through the internal fluid passage as water travels through the sidewall opening and down through the internal passage of the tubular member.

In a variation of the implementation of the preceding paragraph, the structure with the internal fluid passage is an upper extension of the sidewall of the tubular member.

In an embodiment, the valve assembly includes an outlet opening and a movable member connected for movement by a float located in the collection space, the movable member having a lowered position in which the outlet opening is entirely or substantially entirely closed off to prevent or substantially restrict flow from the collection space through the outlet opening, as the movable member rises upward from the lowered position flow area of the outlet opening is increasingly revealed to permit increasing flow through the outlet opening and thus increasing flow through the structure.

In an implementation of the embodiment of the preceding paragraph, the outlet opening is in the movable member and rising movement of the movable member moves more and more of the outlet opening upward beyond a stationary outlet opening obstruction. In another implementation of the embodiment of the preceding paragraph, the outlet opening is in a stationary member that lies adjacent the movable member, and rising movement of the movable member exposes more and more of the outlet opening.

In another aspect, a method of controlling the filtration of stormwater through a media bed involves: providing an internal collection space within the media bed, the internal collection space having a maximum level; delivering stormwater through the media bed for filtration and then into the internal collection space; varying outflow of filtered stormwater from the collection space between a minimum outflow rate and a maximum outflow rate as water level within the internal collection space varies such that: (i) below a threshold level of filtered stormwater within the collection space the outflow is not increased or is only increased as a function of head pressure effect on flow through an outlet orifice of unchanging size; and (ii) above the threshold level of filtered stormwater within the collection space the outflow is increased by increasing flow area size of an outlet opening from the collection space.

In an implementation of the method of the preceding paragraph, the increase in outflow is achieved utilizing a valve assembly including a movable tube that is connected for movement with a float in the internal collection space, as the movable tube moves further and further upward, more and more of an outlet opening in a sidewall structure of the valve assembly is revealed to permit increasing outflow through the sidewall opening.

In a variation of the implementation of the preceding paragraph the sidewall structure is a sidewall of the movable tube. In another variation the sidewall structure is stationary.

In an implementation of the moving sidewall structure variation of the preceding paragraph, the sidewall of the movable tube extends upward to the float and an air inlet is positioned to allow air to flow from above the float and downward through the movable tube as stormwater passes through the outlet opening.

In another implementation, the increase in outflow is achieved using a valve assembly that includes an outlet opening and a movable member connected for movement by a float located in the collection space, the movable member having a lowered position in which the outlet opening is entirely or substantially entirely closed off to prevent or substantially restrict flow from the collection space through the outlet opening, as the movable member rises further and further upward from the lowered position flow area of the outlet opening is increasingly revealed to permit more and more flow through the outlet opening and thus increasing flow through the media bed.

In one variation of the implementation of the preceding paragraph, the outlet opening is in a sidewall of the movable member. In another implementation, the outlet opening is in a sidewall of a stationary portion of the valve assembly that lies adjacent the movable member.

In another aspect, a method of controlling flow of stormwater through a filtering media bed invbolves: utilizing a valve assembly positioned to control flow through the media bed, the valve assembly including an outlet opening and a movable member connected for movement by a float that responds to water level, the movable member having a lowered position in which the outlet opening is entirely or substantially entirely closed off to prevent or substantially restrict flow from the collection space through the outlet opening; as the movable member rises further and further upward from the lowered position, flow area of the outlet opening is increasingly revealed to permit more and more flow through the outlet opening and thus increasing flow through the media bed; and as the movable member falls further and further downward from a raised position, flow area of the outlet opening is increasingly covered to permit less and less flow through the outlet opening and thus decreasing flow through the media bed.

In one implementation of the methods of any preceding paragraph, the method includes providing a secondary fluid flow path downward through the valve assembly to limit cycling of the valve assembly between open and closed conditions. The secondary fluid flow path can also act as a path for air to escape the internal collection space as water level in to the internal collection space rises.

In another aspect, a stormwater filtration system includes a path along which stormwater flows and a valve assembly for controlling an amount of flow permitted along the path in a variable manner according to water level in a region of the valve assembly. The valve assembly includes a movable tube that is connected for movement with a float in the region, as the movable tube moves further and further upward, more and more of an outlet opening in a sidewall structure of the valve assembly is revealed to permit increasing outflow through the sidewall opening.

The movable tube may be disposed within a corresponding tubular surface.

The movable tube may be configured to rotate under forces created during water flow through the valve assembly.

### BRIEF DESCRIPTION OF THE DRAWINGS

FIG. 1 shows a perspective view of one embodiment of a filtration system for use with live plant matter;

FIG. 2 is a section perspective view of the system of FIG. 1;

FIG. 3 is a section view of another embodiment of a filtration system for use with live plant matter;

FIGS. 4 and 5 are exploded and section views respectively of a filtration system including multiple filtration baskets;

FIG. 6 is a graph of target flow behavior through a stormwater filtration media bed;

FIG. 7 is a schematic view of a valve assembly;

FIGS. 8A-8F shows schematic views of various valve assemblies;

FIG. 9 shows a side elevation of one embodiment of a variable flow valve assembly;

FIGS. 10A-10C show side elevations of the lower portion of the valve assembly of FIG. 9 in lowered, partially raised and fully raised conditions respectively;

FIG. 11 shows a perspective view of a stormwater filtration system that delivers water to storage infiltration chambers;

Fig. illustrates an embodiment shown live plant matter in the media bed;

FIG. 13 is an cross-sectional view of an embodiment with an outflow pipe incorporated into the bottom wall of the treatment cell;

FIG. 14 is a cross-sectional view of an upflow embodiment;

FIG. 15 is a cross-sectional view of an embodiment with a filter basket that includes multiple internal collection spaces;

FIG. 16 is a partial cross-section of a filter structure and associated valve assembly with valve lowered;

FIG. 17 is an enlarged view of the lower portion of the valve assembly of FIG. 16;

FIG. 18 is a partial cross-section of the filter structure of FIG. 16 with valve assembly raised;

FIG. 19 is an enlarged view of the lower portion of the valve assembly of FIG. 18;

FIG. 20 is a perspective view of the filter structure of FIG. 16.

### DESCRIPTION

A runoff reduction planter system is provided and operates as a treatment and on-site infiltration product designed to match the runoff reduction goals of new stormwater regulations while working within the typical constraints of modern site design. The system offers a high treatment capacity, attractive vegetated footprint, extended maintenance life and modular design.

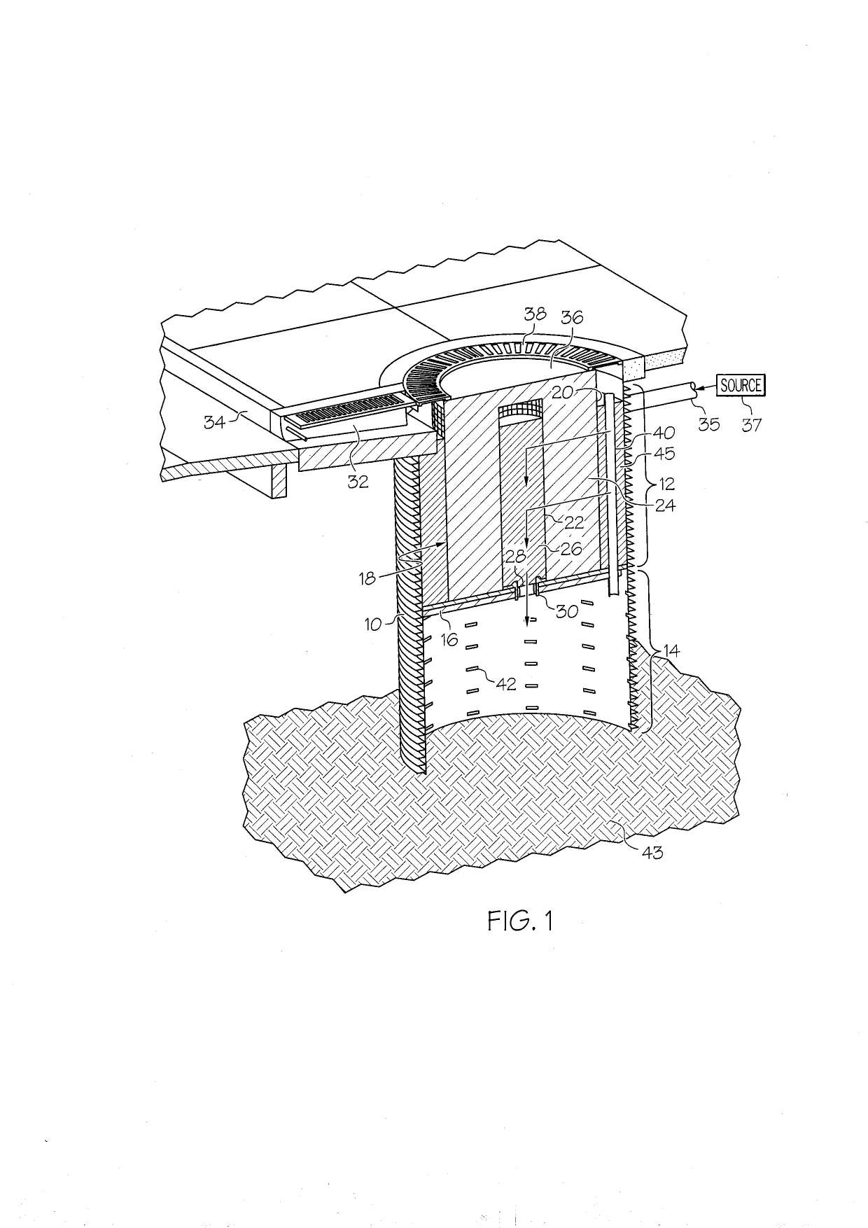

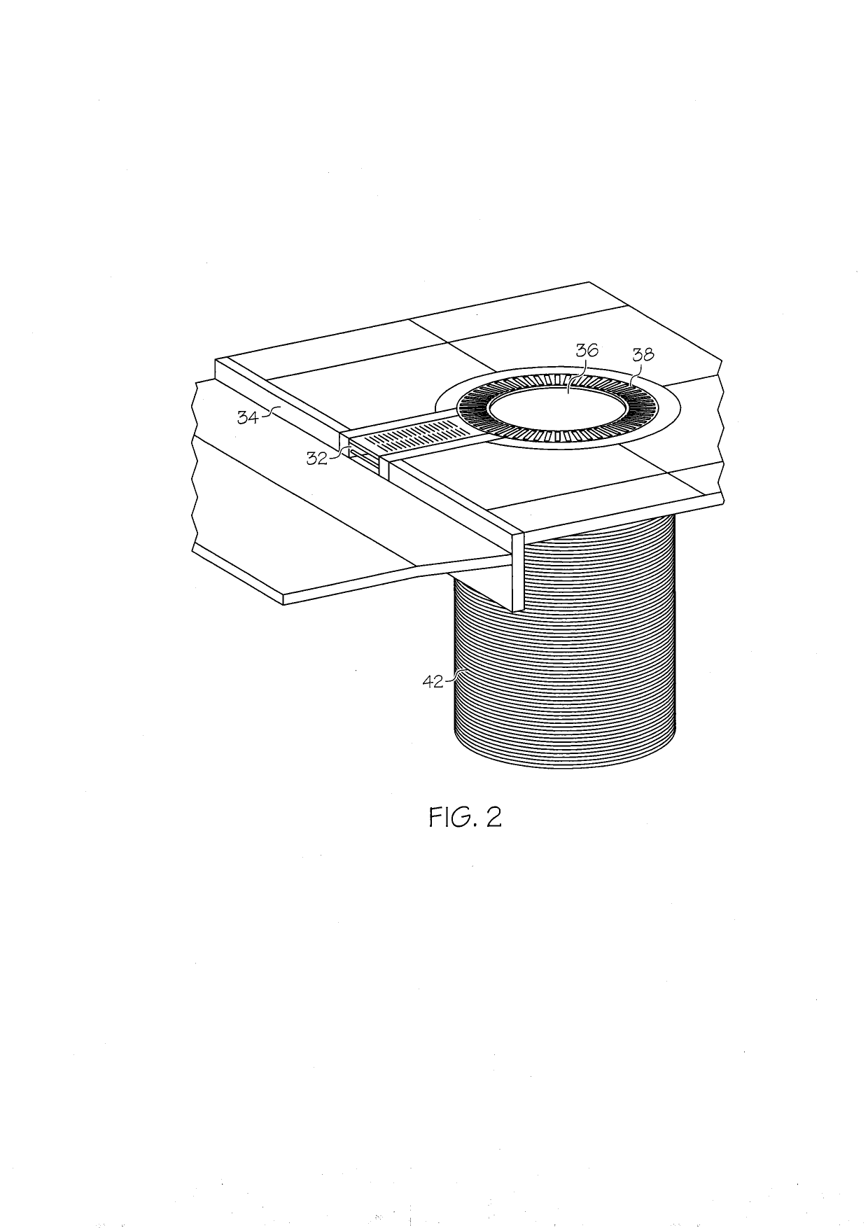

As seen in the embodiment shown in FIGS. 1 and 2, the runoff reduction planter system includes a buried chamber structure 10 (e.g., in this case a steel reinforced polyethylene pipe structure, but alternatively a corrugated metal pipe (CMP) structure, concrete or fiberglass manhole structure or any other suitable structure, including chamber/vaults having other shapes such as square, rectangular or other multi-sided/polygonal configurations of any suitable material). An upper portion of the structure 10 forms a treatment cell 12 and a lower portion of the structure forms an infiltration cell 14, with a lateral platform 16 or other lateral wall structure separating the two cells. A filtration basket 18 is supported by the platform 16 an generally includes a cylindrical outer wire screen 20 forming an outer permeable wall and a spaced apart cylindrical inner wire screen 22 that together define an annular media space 24 of the basket. Although filter basket of right circular cylinder shape is shown, the basket could be square, rectangular or other multi-sided/polygonal configuration. Moreover, while the illustrated basket shape matches the shape of the chamber/vault, the two could have differing shapes (e.g., right circular cylinder basket within a rectangular vault, or visa versa).

Again referring to FIG. 1, the inner wire screen 20 defines a vertically oriented tubular internal collection space 26 with an outlet opening 28 at the bottom. The outlet opening 28 aligns with an opening 30 in the platform 16. A filtration media is located in the media space 24. In one example, the filtration media may be a mixture of sand and pelletized peat (e.g., 75-95% sand and 25-5% pelletized peat), but any variation of media is possible (e.g., such as 100% sand, or a combination of sand, peat, shale; or other combinations of organic and/or inorganic media). In the illustrated embodiment, water enters the treatment cell 12 from a curb inlet 32 associated with curb 34. Water can enter the primary opening of the curb inlet 32 that is exposed to the curb 34 or through openings in a grate atop the curb inlet 32. However, other variations of inlets are possible, including piped connections to the treatment cell sidewall (e.g., as represented by pipe 35) or combinations of inlet types. Moreover, water can also enter the treatment cell at the top through the tree ring type structure 38. The pipe 35 can deliver water from any source 37, such as standard stormwater collection flow, an upstream detention system (e.g. by gravity flow or by a pumped flow from the detention system), direct from a downspout, parking lot or other pumped source.

Notably, the top of the filter basket is open to expose the media and provide a planting area 36 for vegetative matter (e.g., small trees, shrubs and grasses). The planting area 36 is accessible at ground surface level through a central opening in tree ring type structure 38. Vegetative matter planted in area 36 will offer root growth downward into the annular media space 24 such that the roots can take up pollutants etc. captured in or passing through the media.

In operation, water enters the curb inlet (or other inlet) and begins to fill an annular collection and settling space 40 between the basket and the inside wall of the treatment cell. The water travels laterally into the filter basket through wire screen wall 20 and then passes radially through the media space 24 and is filtered by the media and/or root system before passing into the internal collection space 26. The treated water then flows downward into the infiltration space or cell 14 for infiltration into the surrounding earth. In this regard, the chamber structure may include numerous openings 42 of any suitable size and shape to allow radial outward infiltration and/or may sit atop of a bed of gravel or stone 43 to allow infiltration out of the bottom of the cell 14.

While the illustrated embodiment shows the entire vertical height of the chamber/vault sidewalls buried, it is recognized that in some installations some or all of the vertical height (particularly of the treatment cell) could be above ground level, such as when the unit is positioned to receive water from a downspout, downhill from a parking lot or from a pumped source. Although the system may be implemented without plants per FIG. 1, it is contemplated that the primary and most effective use would be with live vegetation and associated root structure as exemplified in FIG. 12.

Notably, the filter basket may be configured to facilitate removal and replacement with another basket if necessary. In a preferred implementation, (i) the dimensions of the basket may range from between about 3 and 5 feet in diameter and about 3 to 5 feet tall, resulting in a significant treatment surface area of about 28 to 79 square feet and treatment capacity of between about 28 and 158 gallons-per-minute (gpm), (ii) the volume of the treatment cell (including space occupied by the basket) may be in the range of between about 392 cubic feet and 679 cubic feet, and (iii) the volume of the infiltration cell may be in the range of between about 0 to 250 cubic feet, with a desired infiltration surface area of 9200 square feet. However, it is recognized that in some cases the infiltration could be directly from the treatment cell into the ground, without making use of the infiltration cell. Likewise, piped outlets from the treatment cell are possible as explained in further detail below.

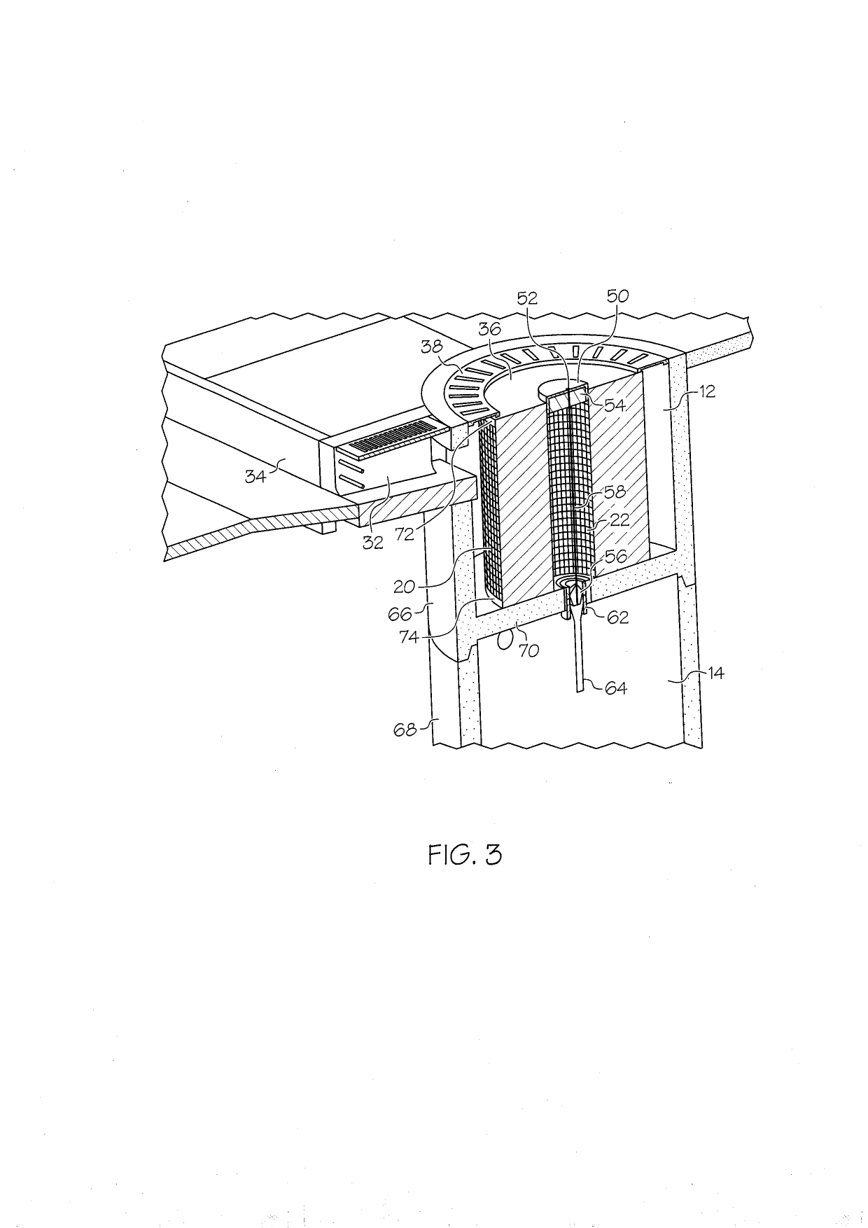

The embodiment of FIG. 1 lacks any moving valve and may use simple static flow control (e.g., a restricted opening size or fixed opening valve) to define maximum flow rate through the filter basket to a level below the initial infiltration capacity of the media bed. However, in one implementation, water begins to flow horizontally through the filtration bed toward the center collection space which is controlled by a float valve (see FIG. 3). Only a trickle flow is allowed to pass through the system until a major portion of the media surface is submerged. Once the water level reaches the activation elevation the valve lifts and allows the full design flow to be reached. The hydraulic conductivity of the media is much greater than the design flow rate, which is governed by an orifice restrictor disc. This intentional reduction in the treatment capacity increases pollutant removal, increases longevity and minimizes maintenance. Once treated, the water flows down into the infiltration chamber 14. The depth of this section may be adjusted to meet volume, infiltration, and drain down requirements. Within the annular space 40 an overflow tube 45 may be provided to deliver water directly from treatment cell 12 to infiltration cell 14, bypassing the filter basket, to assure that the water level does not reach the top of the filter basket.

Although the embodiment of FIGS. 1 and 2 reflects an arrangement in which the collection space is entirely covered by the bed of the planting area (such that the collection space does not extend to the top portion of the bed), in an alternative embodiment the top of the collection space may include an upper region that extends upward through the planting area as shown in FIG. 3. Specifically, a cap member 50 is provided and may include a one way valve 52 to allow air to be released from the collection space as the collection space fills. Such a one-way valve allows the cap at the top of the collection space to fill with water so that the float 54 can move up into the cap, and also aids in the formation of a suction condition during flow such that the water falling through the collection space pulls water through the filter bed. In this regard, an upper portion (e.g., the upper 10-15%) of the tubular structure defining the collection space may be sealed (rather than perforated) to reduce the possibility that air might be drawn into the collection space through the upper surface of the bed. In some embodiments the upper end of the tube may have a two-way air valve or simply an open air path.

Also shown in FIG. 3 is an internal float 54 and valve 56 arrangement within the collection space. Specifically, an upper float member 54 is linked via a rod 58 to a lower valve member 60 having a surface that engages with a seating surface 62 of the basket outlet 28 or passage leading to the infiltration cell 14. An outlet drain tube 64 associated with the path is also shown and extends downward into the infiltration cell (e.g., between about 2 and 20 inches, such as between about 5 and 15 inches, such as between 8 and 12 inches). The increased length of tube 64 increases the suction action that pulls water through the filter media. In the embodiment of FIG. 3 the chamber structure is formed of stacked concrete manhole units 66 and 68, where the upper unit 66 has a unitary bottom wall 70 to support the filter basket. As also shown in FIG. 3, the filter basket may be formed by top and bottom angle rings 72 and 74 with wire basket wall 20 extending therebetween. A woven geotextile may be provided immediately inside the wire screen 20, and similar woven or non-woven geotextile provided about the internal screen 22, both of which help retain the media within the annular media space.

Typically, the filter basket may be assembled within the treatment cell, off-site of final installation, and then transported to the installation site within the treatment cell. This methodology protects the basket during transport and facilitates the use of the treatment cell structure for the purpose of transport. Where the treatment cell and infiltration cell are both used, they may be transported in sections and stacked and sealed on-site at the time of installation.

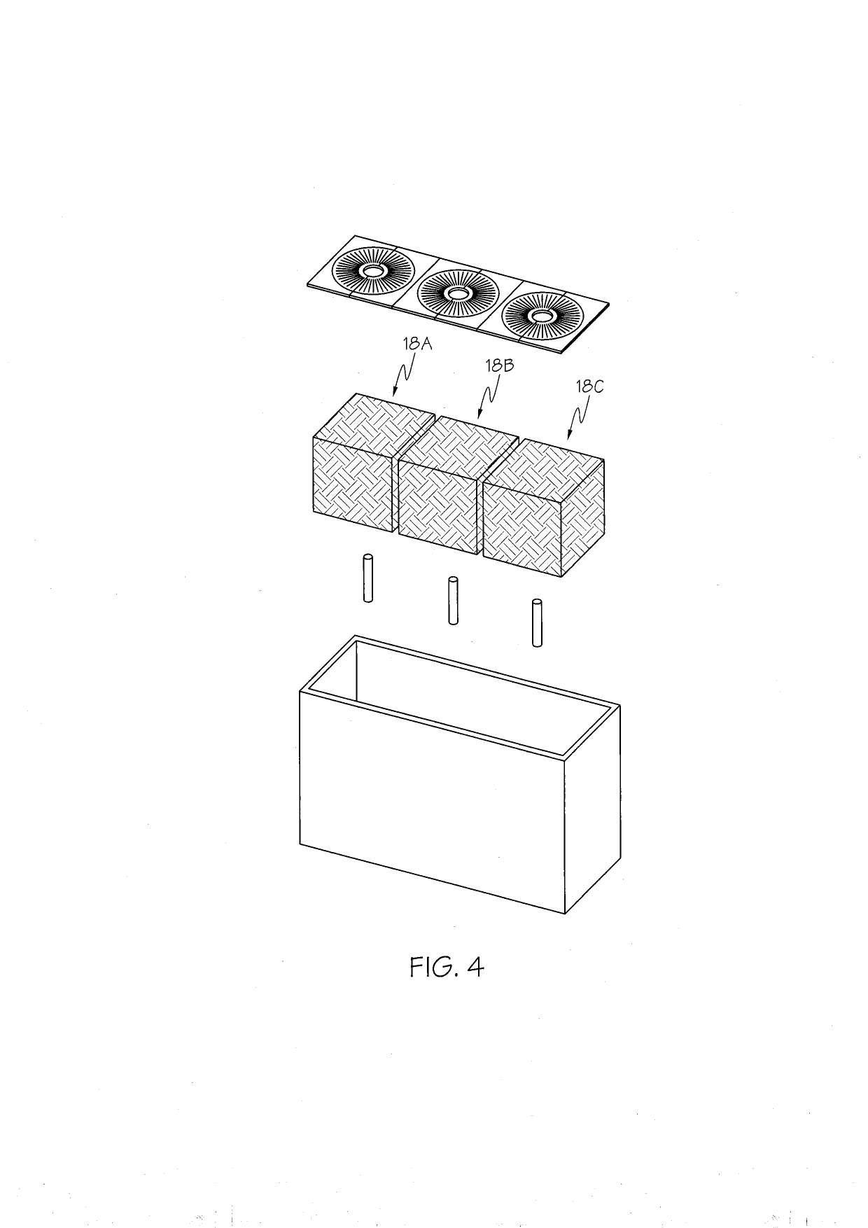

Although the embodiments described above contemplate a single filter basket of generally right circular cylinder shape being located in the treatment cell, variations are possible. For example, FIGS. 4 and 5 show an embodiment in which the filter basket is in the shape of cube, and multiple filter baskets are located in a common treatment cell.

Regardless of the exact shape or number of filter basket structures used, the internal valve system within each filter basket may be configured to provide controlled and desired flow rate through the filter media. Specifically, the hydraulics of the media/center tube arrangement are configured such that a minimum trickle flow rate be maintained over most of the head range to allow for full head levels within the center collection space. This head level is used to achieve the maximum flow rate goal and further to establish standing water column suction thru the media. A variable control feature may be used to minimize differential head. Important to the variable function of the valve at the higher flow rates is that the valve/float arrangement should vary outlet flow area gradually with center tube head to avoid on/off short cycling behavior.

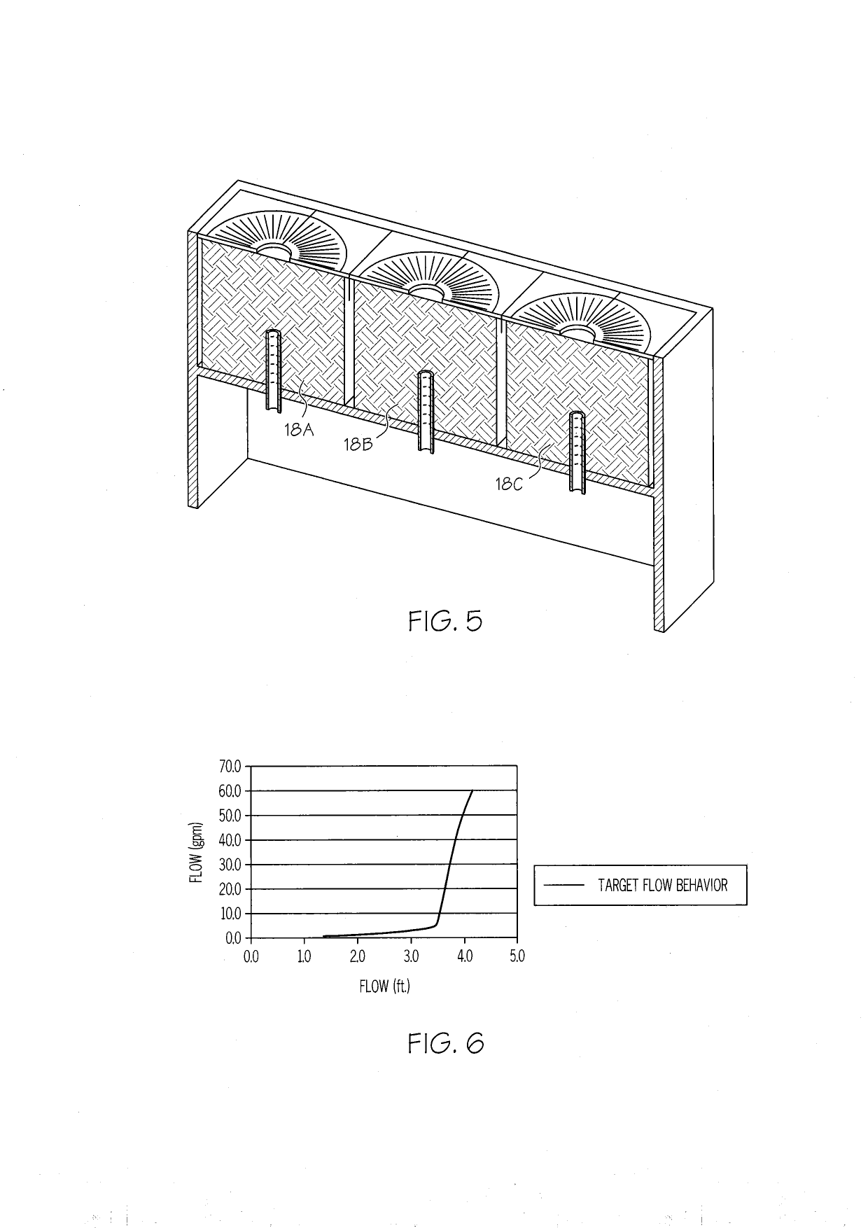

FIG. 6 represents an exemplary ideal flow behavior through one embodiment of a filter basket. Potential valve designs include float actuated in-line flow control valves. Numerous configurations are possible. A primary influence on the operational behavior of the in line obstruction valve concept when actuated is the balance of gravitational to dynamic forces resulting from the restriction within the flow stream. The predominant contributor to these forces is the changing pressure or shape drag resulting from the pressure profile surrounding the obstruction to flow.

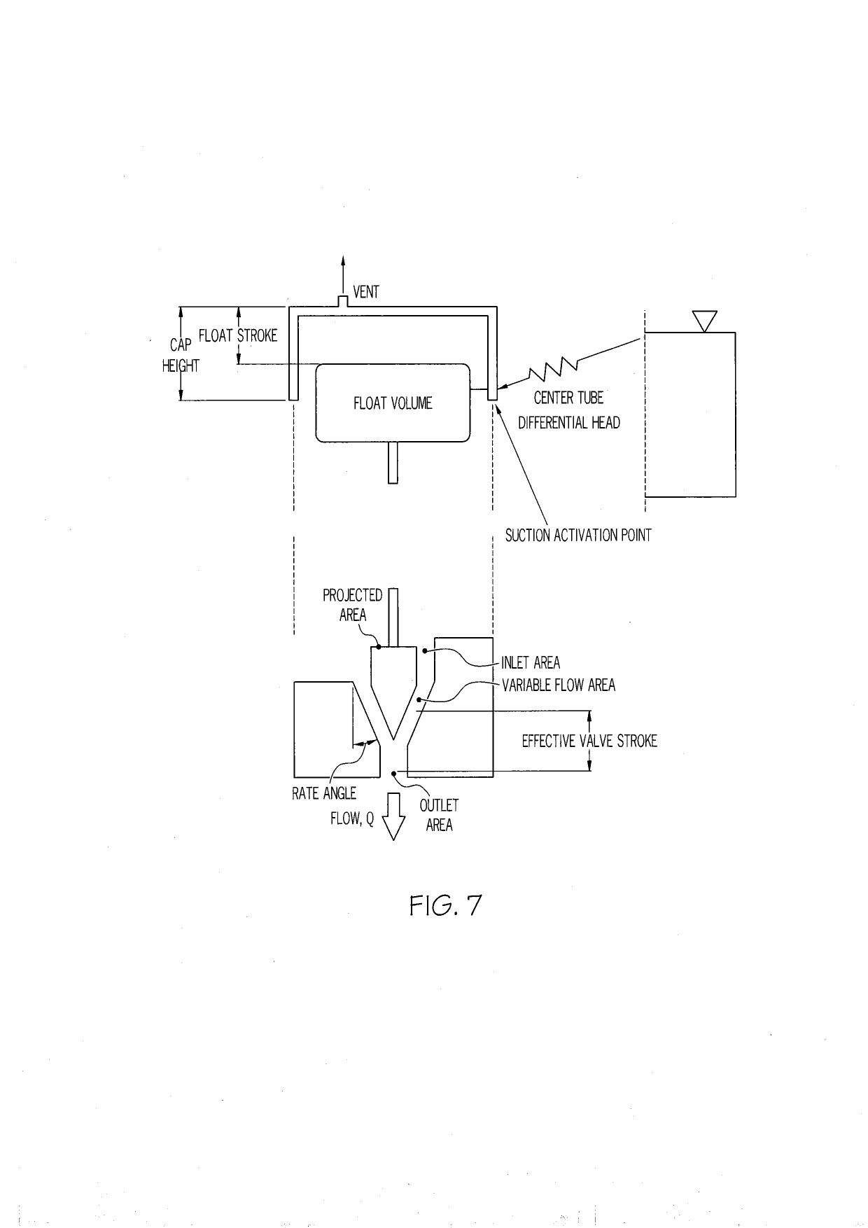

The projected area of the valve obstruction is most influential on these drag forces, with the range of forces from several to 25 or more pounds depending on the size and shape of the valve body. Additional complications to the behavior of the inline obstruction concept relates again to these dynamic forces and how they vary with valve position when filling vs. draining further contributing to short cycle valve actuation. FIG. 7 schematically shows valve design variables that must be taken into account.

As an alternative to the obstruction or plunger type valve, a vertically aligned concentric tube valve might be used. This design has been shown to reduce significantly the projected area and shape effect forces, parallel plate vs. sphere obstruction, but can be vulnerable to particulate jamming when designed for sufficiently low (trickle) flow rates.

In the preferred embodiment, variable valve performance with control of gravitational hydraulic forces within the wide range of flow rate is desired. The valve, with limited available stroke length due to geometries of the system, should operate to effect significant changes in flow area, with the obstruction remaining in the high velocity zone to provide as long of a variable range as possible. Although when remaining in this high flow zone the drag force differential between actuating levels is less, the rapid rate of change of flow area results in similarly dramatic force dynamics and on/off cycling response.

In theory, the velocity at a given head level should remain relatively constant as indicated by the equations below:

V=Q/A_{f}=Cₒ(2gh)^{1/2} (1)

F_{D}=c_{d}e Aₚ(V²/2gc) (2)

F_{B}=e g V_{F}−W (3)

However, in this case the changing geometry of the orifice and dramatic changes in volumetric flow contribute to the dynamic behavior. Equation 1 is a simplified Bernoulli's equation for discharge from a tank and relates the flow velocity to hydraulic head and orifice geometry. Equation 2 is a derived relationship for the form or pressure downward drag force on an object in a fluid stream and shows the influence of projected area, flow velocity, and the shape drag coefficient. Equation 3 defines the relationship for net buoyancy lift of the valve, float buoyancy less weight of the actuating assembly.

The above coefficients Co and Cd vary widely for size, shape, and fluid pressure distributions for both before and after the orifice and surrounding the surface of the object in the flow stream. Valve behavior has been observed to tend along these relationships with force balance changing with actuation cycle of the valve.

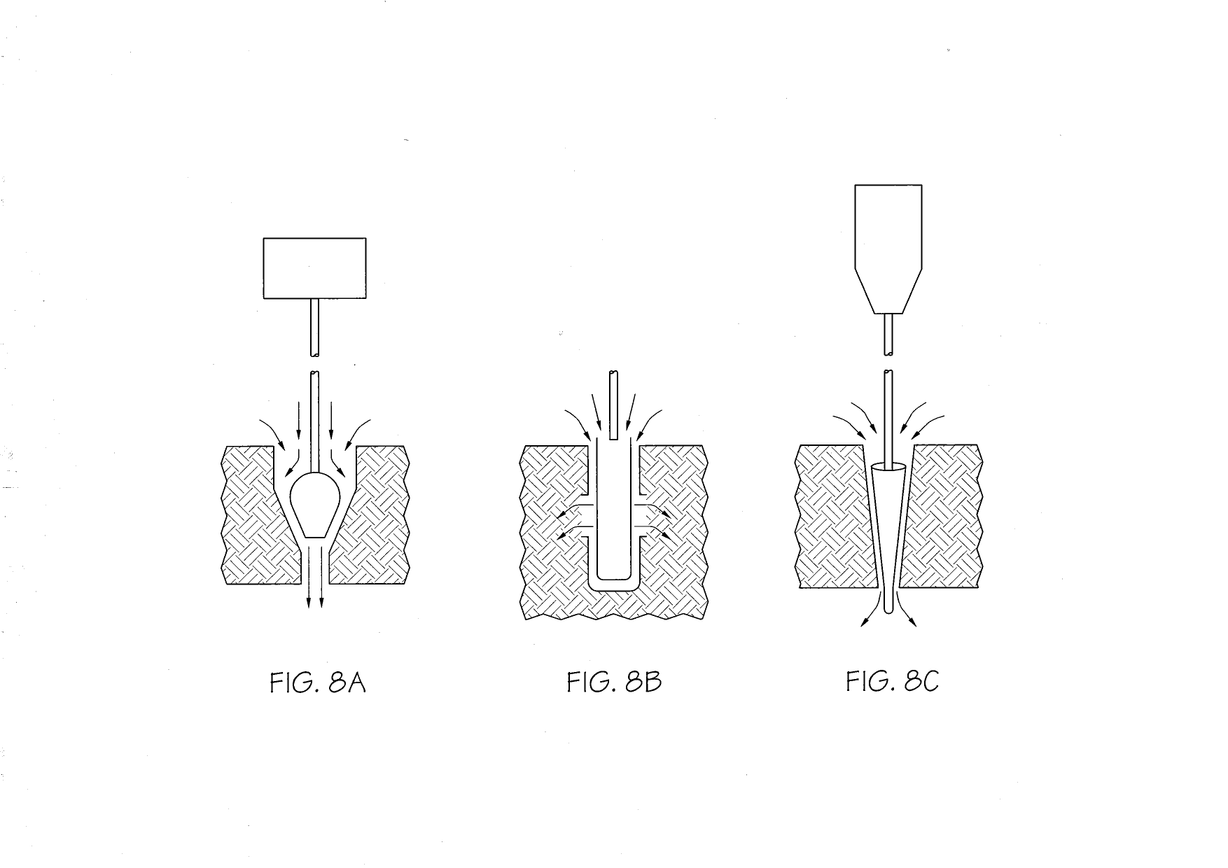

Exemplary valve configurations are shown in FIGS. 8A-8F. However, even these valve configurations have a tendency to cycle between open and closed conditions due to the water flow affects.

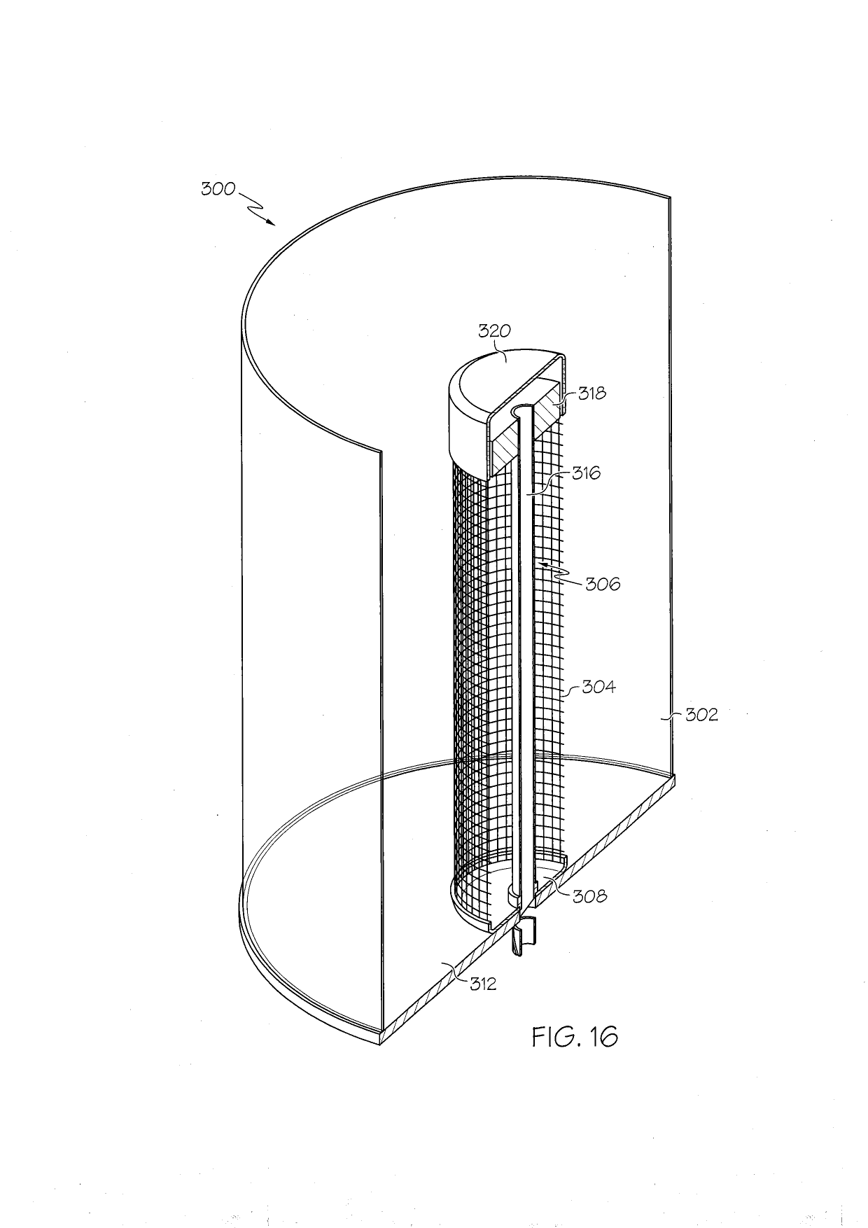

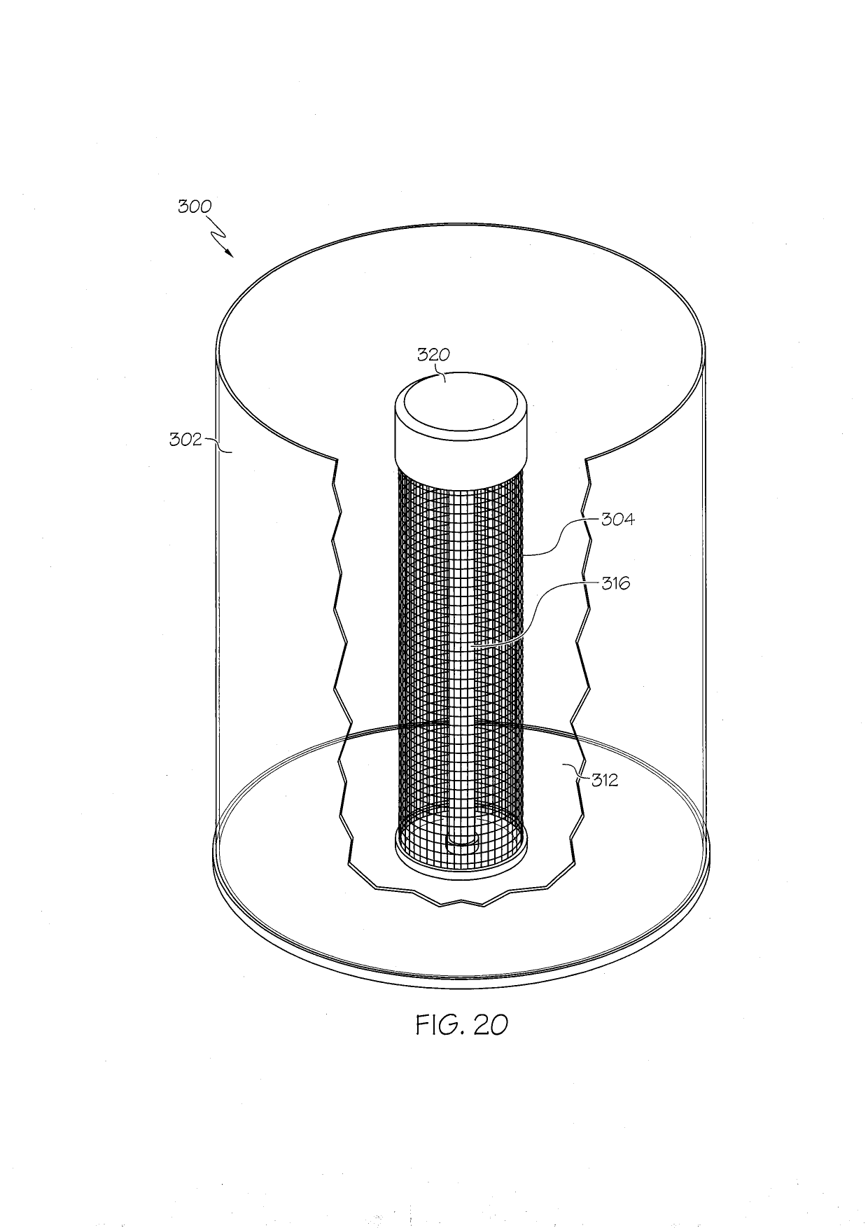

In the desired implementation, water enters the basket collection space and a small trickle leaves the collection space downward and enters the infiltration cell. As the collection space begins to fill with water air is purged through the one-way valve at the top of the space (or in embodiments such as FIGS. 16-20 below the air exits by traveling downward through the valve assembly the controls stormwater outflow). When the water level reaches the activation point (i.e., point where valve movement will begin), the collection space is no longer open to atmosphere, and water can only exit the collection space as it is refilled by water flowing through the media, creating a suction, inside the collection space. The positive head pressure outside the filter basket combined with the suction pressure in the collection space creates a more uniform pressure gradient across the media from bottom to top. The total flow rate is still well below design flow rate because the valve is still closed and only the drain down orifice is open to permit the trickle. As the water level in the collection space increases above the activation point, the valve begins to move and the orifice/opening control window for downward flow into the infiltration cell begins to open, increasing the operating rate of the unit. If the flow rate into the unit is greater than the operating rate, the water depth in the collection space continues to rise and the valve moves further and the orifice window opens larger, further increasing the flow rate through the basket. In this way, the basket only operates at the maximum flow rate when the maximum design storm occurs such that, during smaller storm events the flow rate through the media is generally lower and therefore treatment more effective due to higher contact time with the media. The longevity of the filter basket media is also enhanced due to longer settling out time before water flows into the filter basket.

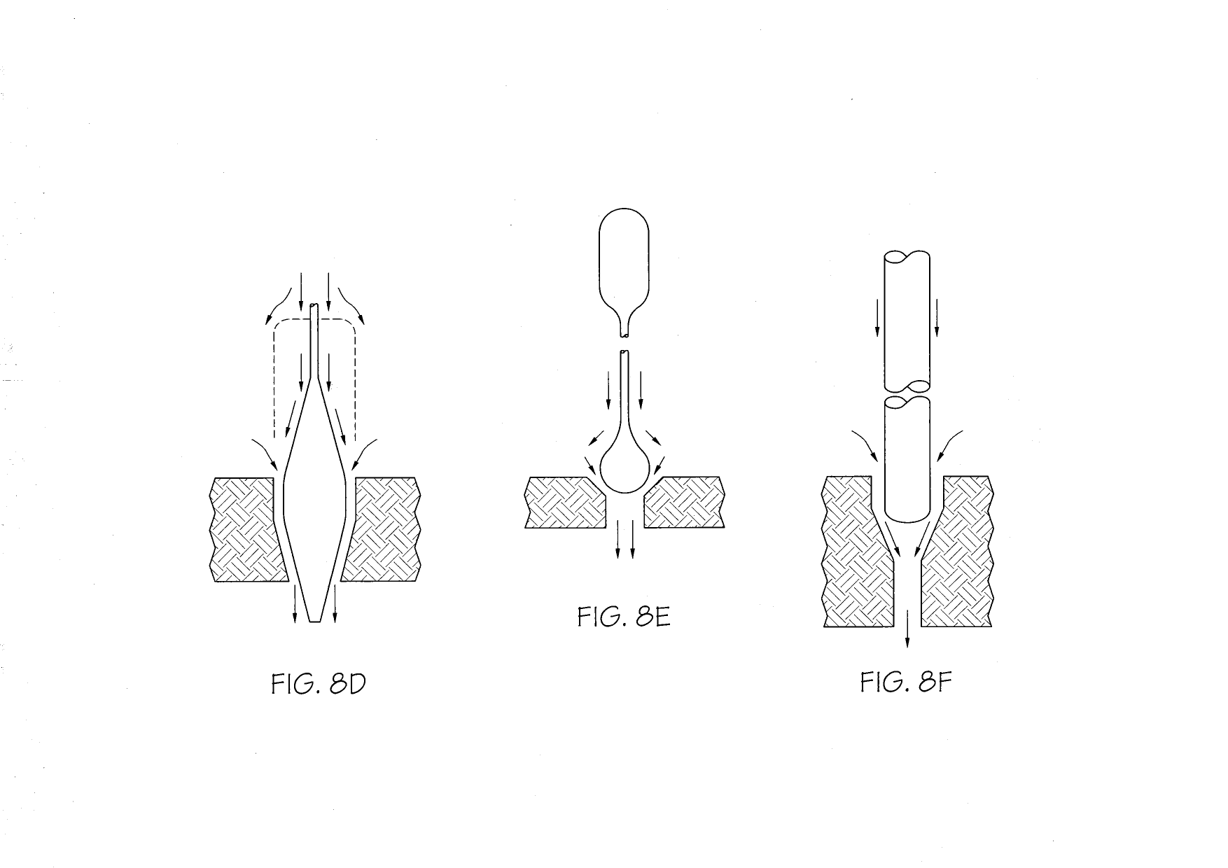

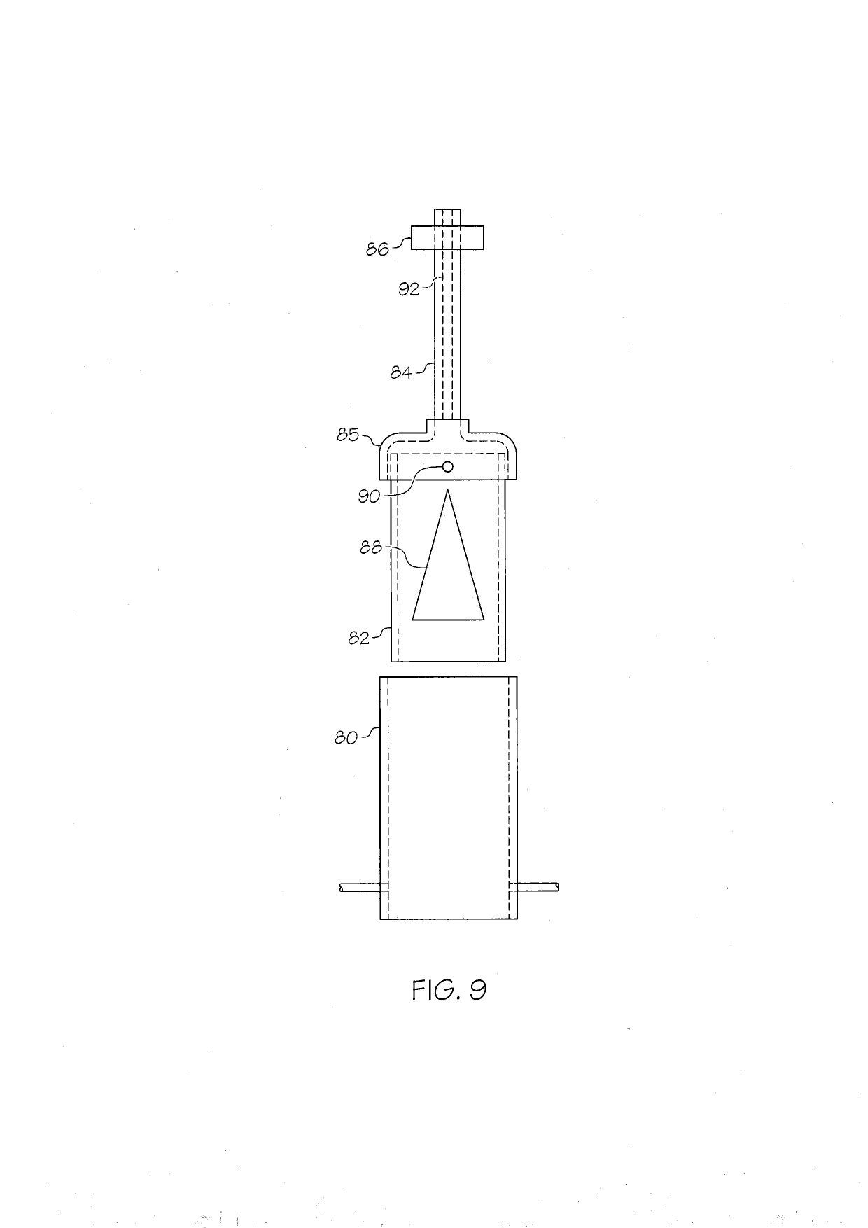

Referring now to FIGS. 9 and 10A-10C, a valve embodiment that reduces dynamic drag and is therefore more practical to implement on a commercial basis is shown. The valve includes an outer tube 80 and an inner tube 82 sized to be inserted within tube 80. Although the tubes are shown as being right circular cylinder in configuration, other tubular shapes may be used, such as oval cylinders or triangular, rectangular or other multi-sided cylinders. The inner tube is connected to a shaft 84 via coupler 85 and the shaft extends upward to a float 86. The inner tube includes one or more slotted openings 88 through its sidewall, which opening(s) may be shaped and/or positioned such that flow area through the sidewall of tube 82 increases when moving from the apex of the opening 88 downward along the height of the tube 82. In the illustrated embodiment the slot 88 has a weir-type shape such that the flow area through the sidewall of tube 82 increases progressively (i.e., the first inch of reveal of the slot may result in a flow area of X m², the second inch of reveal of the slot may result in an additional flow area of 1.5X m² or 2X m² and the third inch of reveal of the slot may result in additional flow are of 2X m² or 3X m² (i.e., total flow area in the first two inches of 2.5X m² or 3X m² and total flow area in the first three inches of reveal of 4.5X m² or 6X m²). However, other embodiments are contemplated. For example, the sidewall opening may be rectangular in which case the flow area will increase linearly as the water level in the collection space rises.

When the tube 82 is in a lowered position within tube 80 (per FIG. 10A), the slot 88 is fully within the tube 80 and flow into the slot 88 is prevented by the contact between the outer wall of tube 82 and the inner wall of tube 80. Likewise, flow into the tube 80 is also prevented by such contact. In this regard, one or more flexible seal members may be provided between the two surfaces. When tube 82 is partially moved upward (per FIG. 10B) by the action of the float as the internal collection space of the basket fills, the slot 88 is revealed and flow from the collection space, through the slot and downward through the tubes 82 and 80 into the infiltration cell below can occur. As the float rises higher, the tube 82 moves further upward exposing more of the slot 88 (per FIG. 10C) permitting more flow out of the collection space.

A trickle opening 90 may also be provided as shown to allow a small flow even when the valve is in the closed position of FIG. 10A, thereby enabling substantially complete drain down of the collection space even when the valve is closed.

In an alternative arrangement, the stationary outer tube 80 may include the sidewall opening slot and movement of the inner tube 82 upward and downward may respectively reveal and close the flow area of the opening. Moreover, in such an arrangement where the opening is in the outer tube, the inner tubular member could be merely an arcuate panel that aligns with the sidewall opening of the outer tube, with the top of the outer tube closed and the connection structure 84 slidingly extending upward through the top of closed upper end of the outer tube.

It is recognized that the variable flow control valving described above can also be incorporated into more traditional stormwater filter cartridges, such as those shown in U.S. Pat. Nos. 5,707,527 or 7,214,311 (copies attached—where the variable flow valve structure would replace the valve structure described in such patents), or other commercially available stormwater filtration cartridges, as well as other stormwater filtration systems where there is a similar desire to variably control flow through a bed of filtration media, regardless of bed orientation.

The float valve utilized in the filter basket structure described herein could also incorporate an air passage 92 (see FIG. 9) that extends vertically upward to allow air to enter or escape from the outlet. Specifically, as the collection space within the basket fills with water, the air in the collection space is pushed upward by the rising water and then downward through the passage 92. The rising water level causes the float to move upward toward the raised position (e.g., FIGS. 10B and 10C) and a negative pressure can be established in the housing that draws fluid through the filter medium as previously described, as well as drawing water up into the cap, displacing the air, which allows the float to rise within the cap member. As water level outside the basket drops, the water level in the collection space likewise drops and the float moves back downward to place the valve in the closed position (e.g., per FIG. 10A), at which point air enters the collection space by moving upward (e.g., from the infiltration cell) through the air passage 92 enhancing backflow effect through the filter medium. The passage 92 acts as a secondary fluid passage through the valve assembly that can limit cycling of the valve.

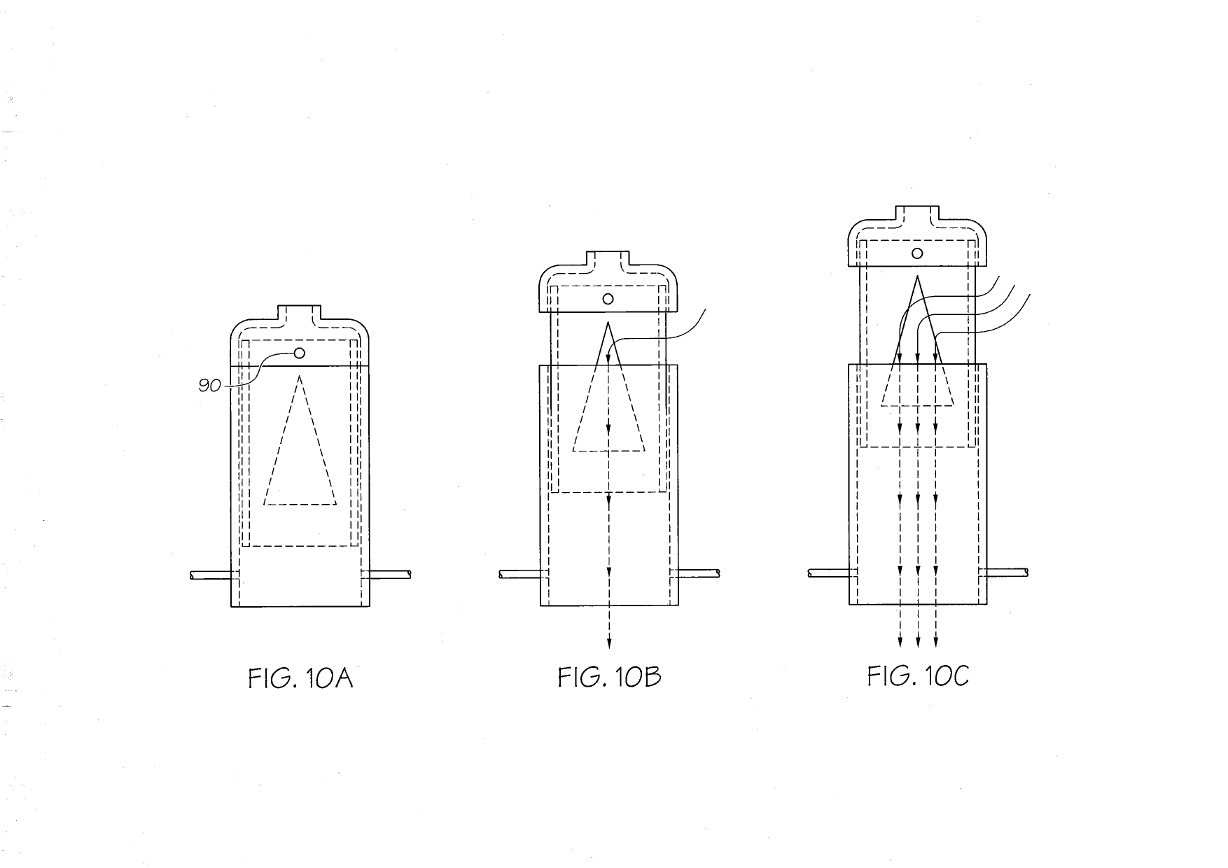

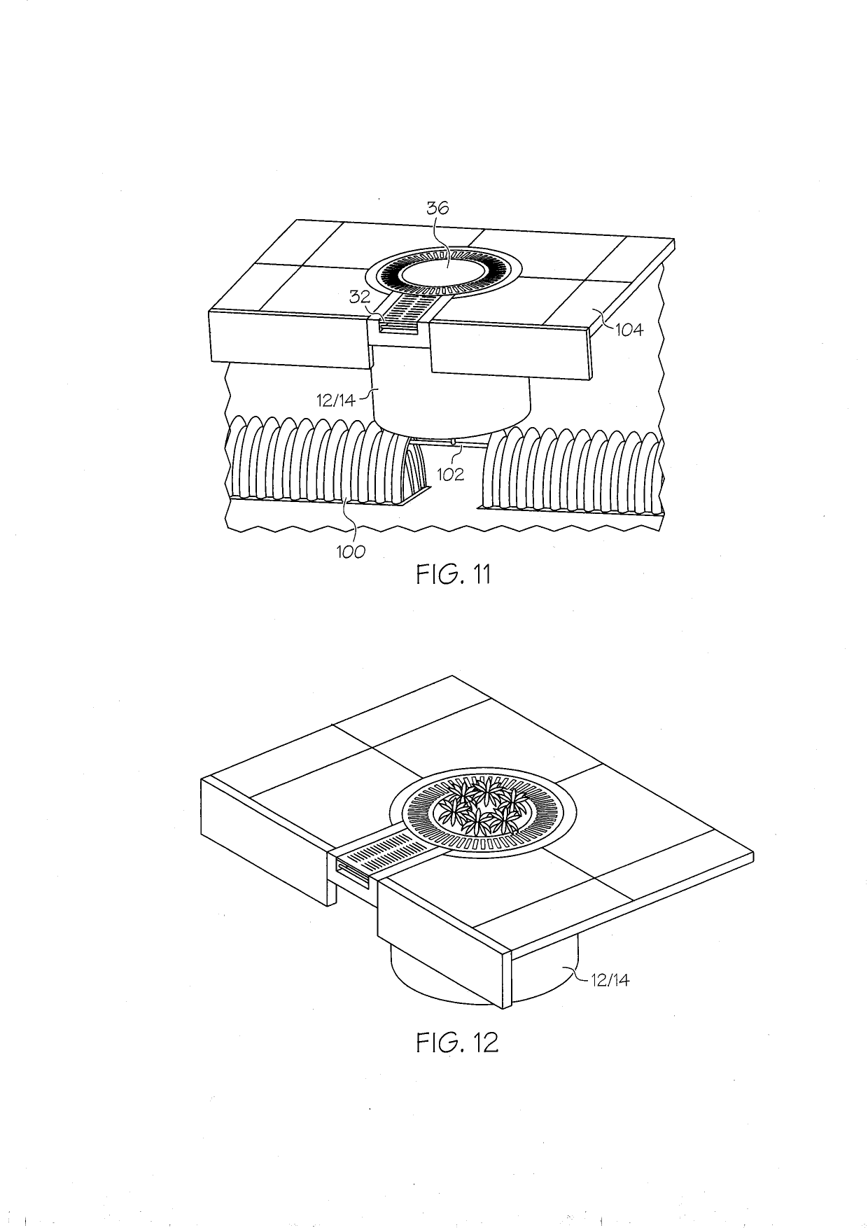

Variations and modifications of the runoff reduction planter system are possible. For example, embodiments in which no infiltration cell is provided are contemplated, such as an embodiment in which the outlet(s) from the treatment cell feed directly into a permeable gravel space below the treatment cell. In the embodiment of FIG. 11, the treatment cell may be connected to deliver treated water (and possibly flows in excess of treatment capacity of the treatment cell) directly to one or more buried infiltration chambers 100 via a pipe arrangement 102. Alternatively, in the embodiment of FIG. 11 the infiltration cell may be included below the treatment cell, with the infiltration cell including an overflow to the infiltration chambers 100 via the pipe arrangement 102. The infiltration chambers are shown as open bottom plastic arch-shaped units, but the infiltration chambers could be formed of other structures (e.g., perforated metal, plastic or composite pipe or concrete structures with no bottom wall or with a permeable or perforated bottom wall). Likewise the outlet of the system (e.g., directly from the treatment cell) could be directed to any of a pipe for downstream flow, a drywell, a rock trench, a drain field, or any suitable detention structure (e.g., non-perforated metal, plastic or composite pipe or non-permeably concrete structures). In this regard, reference is made to FIG. 13 that shows a system in which the chamber 20 is formed by a concrete vault with bottom and side walls, and the filter basket with vegetation and root system is supported on the bottom wall. The outlet opening at the bottom of the internal collection space 26 feeds to a pipe 200 embedded in the bottom wall of the concrete vault for delivering filtered stormwater to an external pipe 202 connected thereto. Pipe 202 may lead to a downstream system 204 that is formed by any suitable infiltration, detention or treatment structure. It is also possible that a lateral outlet pipe could be placed at the bottom of the bed as suggested by dashed lines 206. An overflow outlet may also be provided from the collection and settling space 40 for delivering excess flows that enter the collection and settling space (e.g., flows in excess of the treatment capacity of the filter basket) out of the treatment cell without such excess flows traveling through the filter structure and before such excess flows cause water level in the collection and settling space to exceed a top of the media bed. In the illustrated embodiment the overflow is shown in dashed line form as a pipe 208 that is open at the top to define the overflow level, with the lower end of the pipe connected to the outflow pipe 202 or 206. However, the overflow could be, for example, through the sidewall of the treatment cell and then to the outflow piping.

Referring again to FIG. 11, the illustrated surrounding pavers 104 may be permeable or non-permeable. FIG. 12 also shows an embodiment with vegetative matter included.

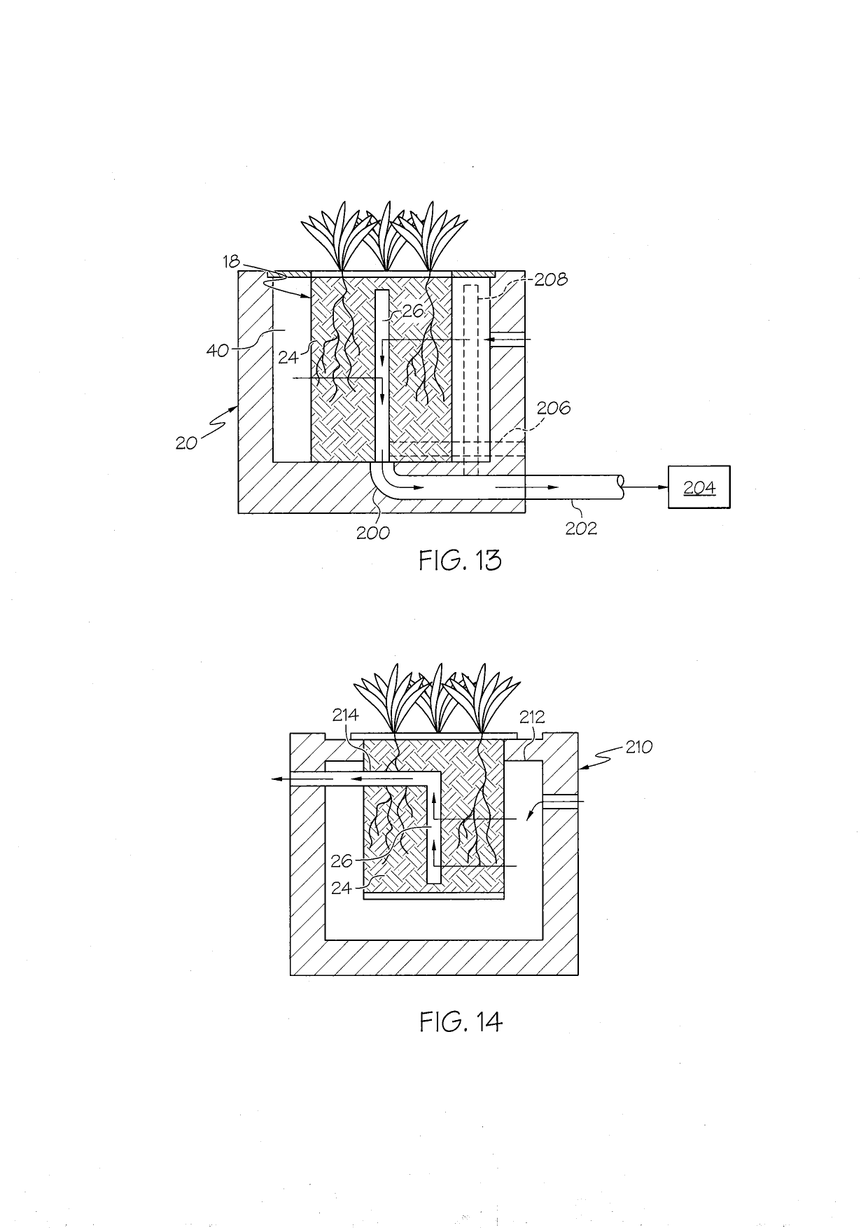

Referring to FIG. 14, an alternative upflow embodiment of the system is shown in which the filter basket 18 is supported in a chamber 210 by vault ledge 212 such that the bottom of the filter basket is above the bottom of the treatment cell. The collection space 26 extends vertically upward and connects with a lateral pipe 214 for delivering the water out of the basket and the chamber.

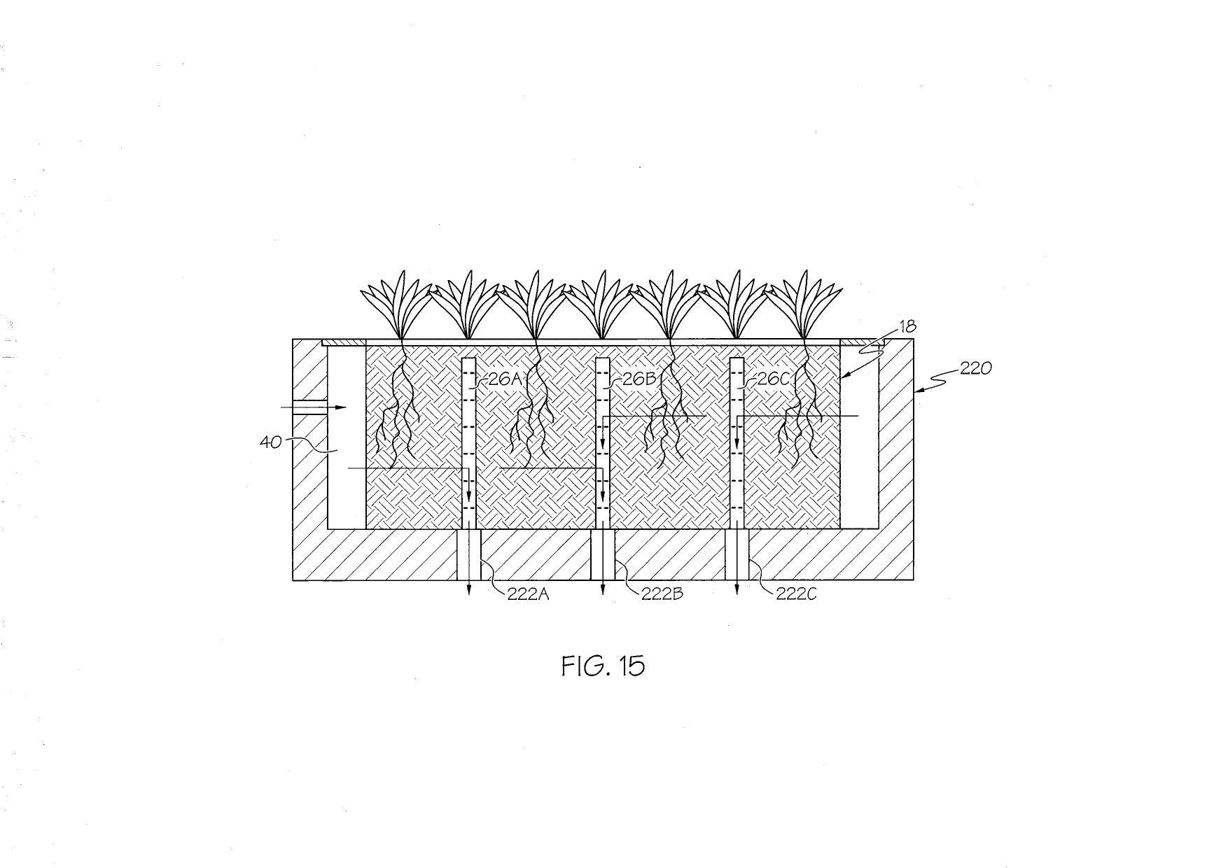

Referring to FIG. 15, an alternative embodiment of the system is shown in which the chamber 220 incorporates a filter basket 18 (e.g., an elongated rectangular basket) that includes multiple internal collection spaces 26A, 26B and 26C, each of which is connected with a corresponding bottom outlet 222A, 222B and 222C that may feed to a common infiltration cell or common piping.

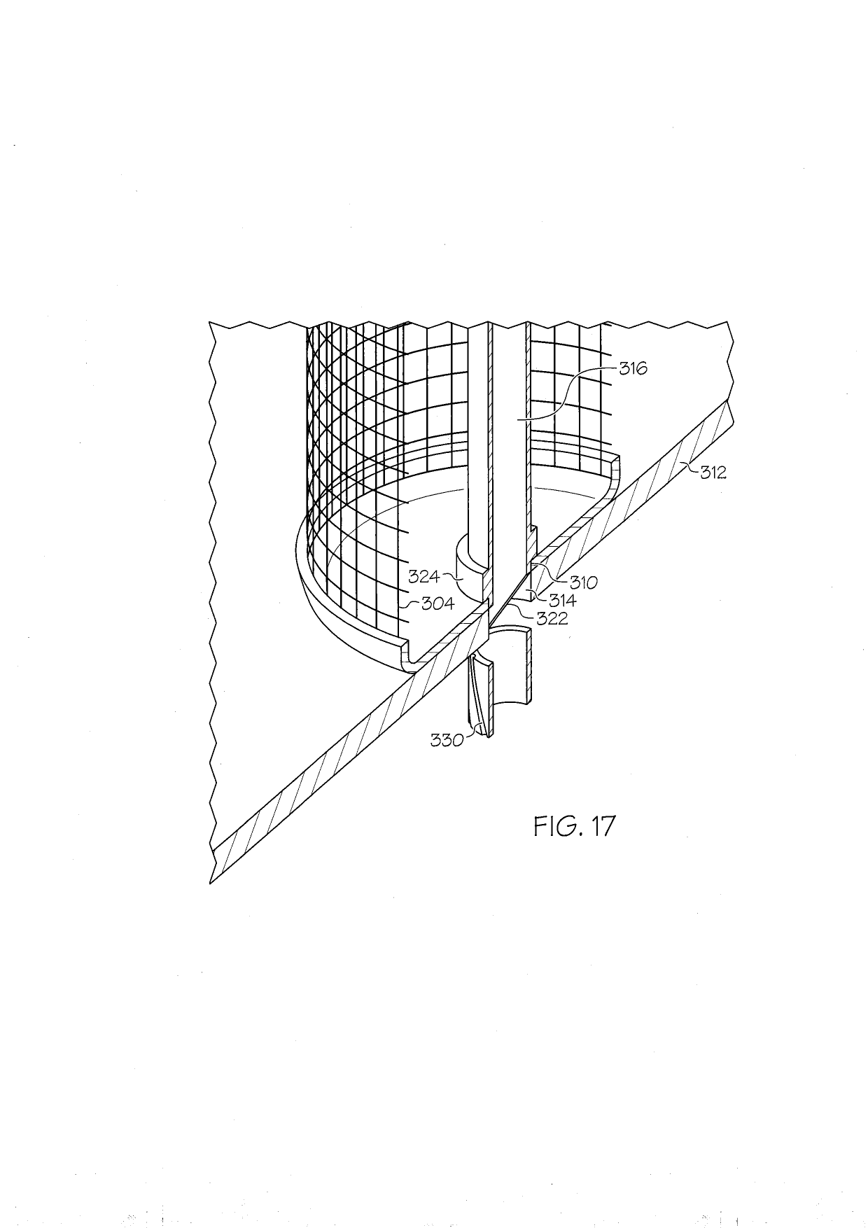

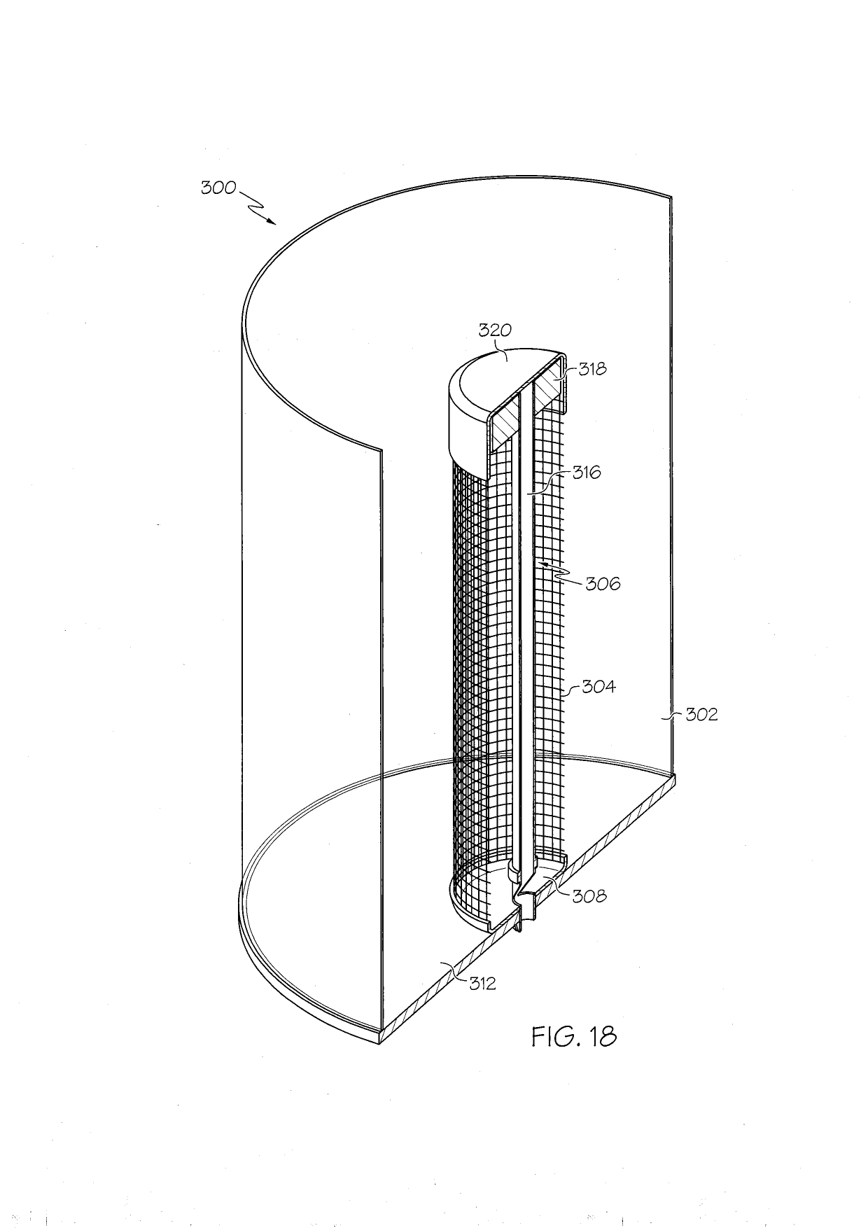

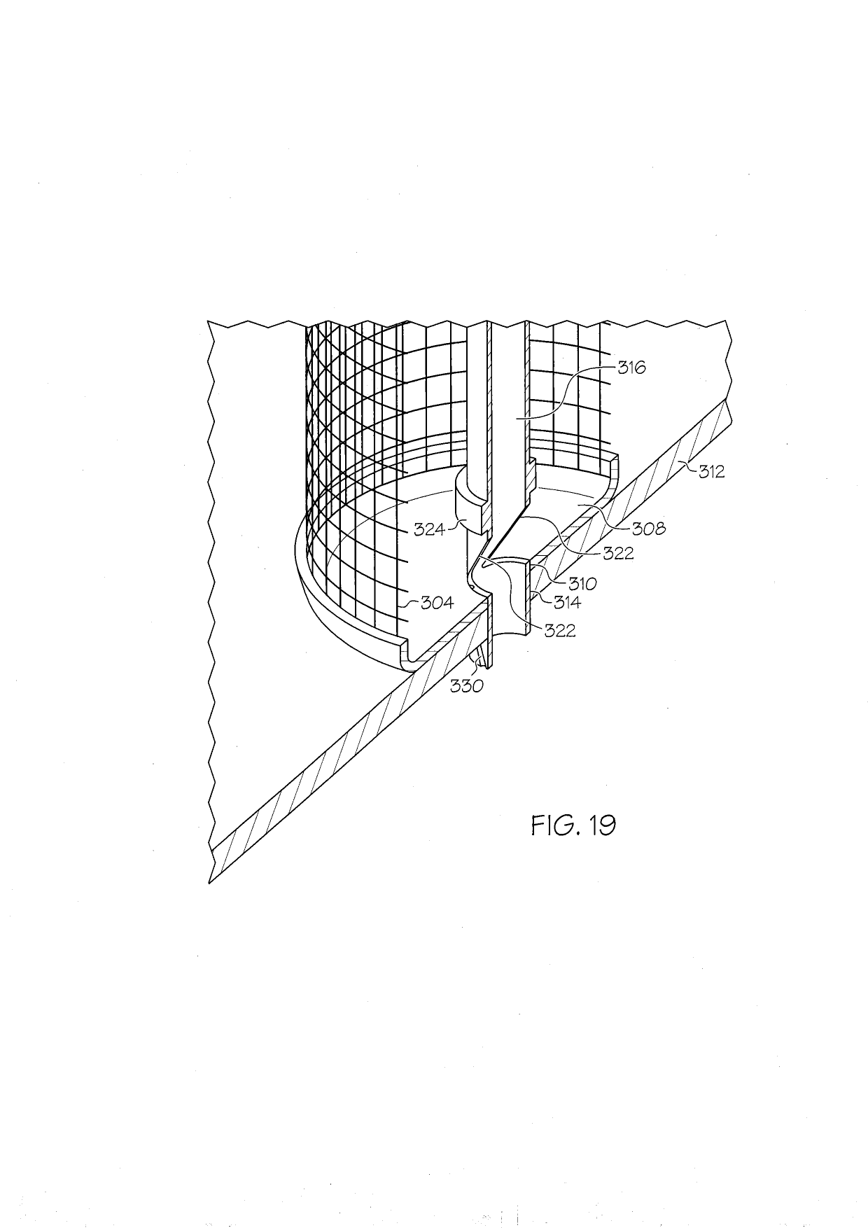

Referring now to FIGS. 16-19, a cross section of a filter structure 300 (e.g., filter cartridge or filter basket for holding vegetative matter) is shown in which the media would be located between outer permeable wall 302 (e.g., screen and permeable geotextile/fabric) and inner permeable wall 304 (e.g., screen and permeable geotextile/fabric), with an internal collection space 204 defined within the inner permeable wall 304. At the bottom of the filter structure a flanged plate member 308 associated with inner wall 304 includes an opening 310 and a base plate 312 of the filter structure includes a corresponding and aligned opening 314. The internal surfaces of the openings 310 and 314 together define a continuous cylindrical surface through which the lower end of a tubular member 316 extends. The tubular member 316 (shown as right circular cylinder, but other shapes being possible) extends upward to and is connected to a float 318 such that water level in the collection space is movable. FIGS. 16 and 17 show the float and tube in a lowered position and FIGS. 18 and 19 show the float and tube in a fully raised position. A cap member 320 at the top of the internal collection space 306 may effectively limit the upward movement of the float and tube. The lower end of the tube 316 includes a pair of diametrically opposed sidewall openings 322 (shown as triangular, with only half of each opening illustrated due to the cross-section, but other opening shapes being possible) that are fully lowered into the openings 310 and 314 in the lowered position of the tube and float, with no part of the flow area of the openings 322 exposed to stormwater flow from the bottom of internal collection space 306 as shown in FIG. 17. A collar member 322 may be used to limit downward movement of the float and tube. The collar may have a drain down opening similar to opening 90 shown in FIG. 9.

Referring again to FIGS. 16-19, as water flows through outer wall 302, then through the media bed (media not shown) in annular media bed space 326 between wall 302 and then through wall 304 into internal collection space 306, the water level in the collection space begins to rise. Because the float 318 is located near the top of the collection space 306, and because there is no flow, or in the case of a small drain down opening in the collar, substantially restricted flow into the tube, flow downward out of the internal collection space 306 does not increase during such water level rise, or is only increased as a function of head pressure effect on flow through the drain down outlet orifice, until the water level reaches the float 306 and begins to cause both the float and tube to move upward. Typically, the float may be located at a height along the upper twenty percent of the overall height of the collection space, or the float at least does not begin to move until the water level in the collection space reaches such upper twenty percent. In more preferred embodiments the float and tube do not begin to move upward until the water level reaches the upper fifteen percent (or even ten percent) of the overall height of the collection space.

The water level that initially causes upward movement of the float and tube may be considered a threshold water level of valve operation. Once the float and tube begin to move upward, the sidewall openings 322 of the tube will begin to be exposed, with more and more flow area of the sidewall openings being revealed as the float and tube move further and further upward. Thus, more and more flow out of the collection space 306 is permitted as the tube and float move further and further upward. Likewise, as flow into the filter structure decreases below the full flow limit, the water level in the collection space moves further and further downward from the fully raised position, and the flow area of the sidewall outlets is increasingly covered to permit less and less flow through the outlet openings and thus decreasing flow through the media bed. In this manner, the valve assembly is able to provide a variable outflow that seeks to closely match the incoming flow.

Notably, the tube 316 is open at the top to provide a fluid passage downward through the full length of the tube. Thus, as the water level in the collection space 306 rises, displaced air can enter the top opening and move downward through the tube and out of the filter structure to prevent creation of an air lock condition. Water is also pulled upward into the cap, displacing air, and allowing the float to rise within the cap. This feature is particularly useful in embodiment in which the top of the collection space is covered by the upper portion of the media bed (e.g., as per the FIG. 1 configuration). Moreover, the inclusion of the fluid passage from the top of the tube downward reduces the likelihood that suction effects produced by flow conditions through the sidewall openings 322 and downward out of the structure will tend to pull the float and tube downward to the lowered position prematurely (i.e., before the water level in the collection spaced moves back down to the threshold level). Accordingly, the subject valve assembly is able to provide effective and reliable variable flow control through the filter structure, without the repeated cycling between open and closed conditions that would be experienced using previously known valve structures used in stormwater filtration cartridges. Testing has demonstrated that the inclusion of the fluid passage from the top of the tube downward has shown the ability to produce an enhanced suction head within the filter structure, such that as the flow rate through the valve increases, the suction head also increases, enabling the filter structure treatment rate to increase without requiring any substantial increase in the head level of water about the filter structure. This enables an overall higher flow rate through the filter structure (as compared to the same filter structure using a valve assembly without the secondary fluid passage extending from the top of the tube downward, with a one way air release valve at the top of the collection space).

A further feature that enhances performance of the valve assembly is the provision of vertically and laterally extending recessed grooves 330 in the outer surface of the tubular member 316 in the region below the openings 322. These grooves create a small external pathways through which water can travel once the openings 322 have been exposed, and the flow through such pathways tends to cause the tubular member and float to rotate during outflow conditions, reducing the likelihood that the tubular member will seize up due to frictional forces or the presence of and dirt or media. Thus, a system in which the valve assembly is caused to rotate during outflow has been found to enhance reliability of the valve assembly.

The subject valve assembly can be used in other media bed control applications (e.g., without locating the valve internally of the bed), including horizontal radial flow media beds and vertical flow media beds. The valve could also be used to control other stormwater flows based upon water level, regardless of whether the flow travels through a media bed at all.

While the foregoing embodiments are primarily described as systems in which the chamber structure is buried, it is recognized that variations in which the chamber structure is not buried are possible. For example, the filter basket could sit in a manhole with a perforated base so that and water just flows down through the media through the base. The perforated portion of the base may always be set to a minimum distance from the peripheral edge of the basket.

What is claimed is:

1. A stormwater filtration device, comprising:
one of a filter cartridge structure or a filter basket structure including an internal collection space surrounded by a filter media bed, an outlet opening toward the bottom of the internal collection space for delivering water out of the structure, and a valve assembly associated with the outlet opening, the valve assembly configured to provide a variable flow out of the outlet opening according to level of water within the internal collection space.

2. The stormwater filtration device of claim 1 wherein the valve assembly includes an outer tube, an inner tube positioned within the outer tube, the inner tube having a sidewall with at least one opening, the inner tube connected for movement by a float located in the collection space, the inner tube having a lowered position within the outer tube in which the sidewall opening is within the outer tube to prevent flow from the collection space through the sidewall opening, as the inner tube rises upward from the lowered position the sidewall opening is revealed to permit increasing flow through the sidewall opening and thus increasing flow through the structure.

3. The stormwater filtration device of claim 1 wherein the valve assembly is configured to progressively increase a flow area of a valve passage as water level within the internal collection space rises.

4. The stormwater filtration device of claim 1 wherein the valve assembly is configured to linearly increase flow area of a valve passage as water level within the internal collection space rises.

5. The stormwater filtration device of claim 1 wherein the valve assembly includes a tubular member disposed within a corresponding tubular surface, the tubular member having a sidewall with at least one opening, the tubular member connected for movement by a float located in the collection space, the tubular member having a lowered position in which the sidewall opening is entirely or substantially entirely within the tubular surface to prevent or substantially restrict flow from the collection space through the sidewall opening, as the tubular member rises upward from the lowered position the sidewall opening is increasingly revealed to permit increasing flow through the sidewall opening and thus increasing flow through the structure.

6. The stormwater filtration device of claim 5 wherein the tubular member is connected to the float via structure with an internal fluid passage that includes a lower end open to the internal passage of the tubular member and an upper opening located above the float to permit air to move downward through the internal fluid passage.

7. The stormwater filtration device of claim 6 wherein the structure with the internal fluid passage is an upper extension of the sidewall of the tubular member.

8. The stormwater filtration device of claim 1 wherein the valve assembly includes an outlet opening and a movable member connected for movement by a float located in the collection space, the movable member having a lowered position in which the outlet opening is entirely or substantially entirely closed off to prevent or substantially restrict flow from the collection space through the outlet opening, as the movable member rises upward from the lowered position flow area of the outlet opening is increasingly revealed to permit increasing flow through the outlet opening and thus increasing flow through the structure.

9. The stormwater filtration device of claim 8 wherein the outlet opening is in the movable member and rising movement of the movable member moves more and more of the outlet opening upward beyond a stationary outlet opening obstruction.

10. The stormwater filtration device of claim 8 wherein the outlet opening is in a stationary member that lies adjacent the movable member, and rising movement of the movable member exposes more and more of the outlet opening.

11. The stormwater filtration device of claim 5 wherein the tubular member includes one or more recessed grooves along an external surface portion below the sidewall opening and configured such that water passing downward along the one or more grooves during outflow causes the tubular member to rotate.

12. A method of controlling the filtration of stormwater through a media bed, the method comprising:
providing an internal collection space within the media bed, the internal collection space having a maximum level;
delivering stormwater through the media bed for filtration and then into the internal collection space;
varying outflow of filtered stormwater from the collection space between a minimum outflow rate and a maximum outflow rate as water level within the internal collection space varies such that:
below a threshold level of filtered stormwater within the collection space the outflow is not increased or is only increased as a function of head pressure effect on flow through an outlet orifice of unchanging size;
above the threshold level of filtered stormwater within the collection space the outflow is increased by increasing flow area size of an outlet opening from the collection space.

13. The method of claim 12 wherein the increase in outflow is achieved utilizing a valve assembly including a movable tube that is connected for movement with a float in the internal collection space, as the movable tube moves further and further upward, more and more of an outlet opening in a sidewall structure of the valve assembly is revealed to permit increasing outflow through the sidewall opening.

14. The method of claim 13 wherein the sidewall structure is a sidewall of the movable tube.

15. The method of claim 14 wherein the sidewall of the movable tube extends upward to the float and an air inlet is positioned to allow air to flow from above the float and downward through the movable tube as stormwater passes through the outlet opening.

16. The method of claim 13 wherein the sidewall structure is stationary.

17. The method of claim 12 wherein the increase in outflow is achieved using a valve assembly that includes an outlet opening and a movable member connected for movement by a float located in the collection space, the movable member having a lowered position in which the outlet opening is entirely or substantially entirely closed off to prevent or substantially restrict flow from the collection space through the outlet opening, as the movable member rises further and further upward from the lowered position flow area of the outlet opening is increasingly revealed to permit more and more flow through the outlet opening and thus increasing flow through the media bed.

18. The method of claim 16 wherein the outlet opening is in a sidewall of the movable member.

19. The method of claim 16 wherein the outlet opening is in a sidewall of a stationary portion of the valve assembly that lies adjacent the movable member.

20. A method of controlling flow of stormwater through a filtering media bed, the method comprising:
utilizing a valve assembly positioned to control flow through the media bed, the valve assembly including an outlet opening and a movable member connected for movement by a float that responds to water level, the movable member having a lowered position in which the outlet opening is entirely or substantially entirely closed off to prevent or substantially restrict flow from the collection space through the outlet opening,
as the movable member rises further and further upward from the lowered position, flow area of the outlet opening is increasingly revealed to permit more and more flow through the outlet opening and thus increasing flow through the media bed,
as the movable member falls further and further downward from a raised position, flow area of the outlet opening is increasingly covered to permit less and less flow through the outlet opening and thus decreasing flow through the media bed.

21. The method of claim 20, further comprising:
providing a secondary fluid flow path downward through the valve assembly to limit cycling of the valve assembly between open and closed conditions.

22. The method of claim 21 wherein the secondary fluid flow path also acts as a path for air to escape the internal collection space as water level in to the internal collection space rises.

23. The method of claim 20 wherein flow through the valve assembly causes the movable member to rotate.

24. A stormwater filtration system, including:
a path along which stormwater flows;
a valve assembly for controlling an amount of flow permitted along the path in a variable manner according to water level in a region of the valve assembly, the valve assembly including a movable tube that is connected for movement with a float in the region, as the movable tube moves further and further upward, more and more of an outlet opening in a sidewall structure of the valve assembly is revealed to permit increasing outflow through the sidewall opening.

25. The stormwater filtration system of claim 24 wherein the movable tube is disposed within a corresponding tubular surface.

26. The stormwater filtration system of claim 25 wherein the movable tube is configured to rotate under forces created during water flow through the valve assembly.
